(19) United States
(12) Patent Application Publication
(10) Pub. No.: US 2014/0009731 A1
(43) Pub. Date: Jan. 9, 2014

(54) METHODS AND APPARATUS FOR HIGH FILL FACTOR AND HIGH OPTICAL EFFICIENCY PIXEL ARCHITECTURE

(71) Applicants: Michael O'Callaghan, Louisville, CO (US); Wanli Chi, Longmont, CO (US); Mark Handschy, Boulder, CO (US)

(72) Inventors: Michael O'Callaghan, Louisville, CO (US); Wanli Chi, Longmont, CO (US); Mark Handschy, Boulder, CO (US)

(21) Appl. No.: 13/544,476

(22) Filed: Jul. 9, 2012

(51) Int. Cl. G02F 1/1335; G02F 1/1343

(52) U.S. Cl. 349/114; 349/113

(57) ABSTRACT

A liquid crystal panel and method are disclosed for increasing optical efficiency in the panel by using a reflector with a high fill factor and arranging an array of transparent pixel electrodes between the reflector and a layer of liquid crystal.

### FIELD OF THE INVENTION

Embodiments of the present invention are generally related to the field of liquid crystal displays, and, more particularly, to optimizing the optical performance of such displays.

### BACKGROUND

The perceived brightness of a liquid crystal display can depend on the amount of light that exits the display's liquid crystal on silicon (LCOS) panel through a liquid crystal layer of the panel. Having a bright image from the display can provide a better viewing experience to users because brighter images tend to be more visible to the human eye and can provide a more vivid image than darker images. The brightness level of a reflective type LCOS display panel can be a function, at least in part, of the amount of light passing through a layer of liquid crystal after reflecting off of a reflector. A more optically efficient LCOS can provide a higher brightness level for a given amount of light incident on the reflector than a less optically efficient LCOS. Optical efficiency can be defined as a ratio of optical power reflected out of the LCOS panel divided by the optical power of light incident on the panel.

In a conventional reflective type LCOS display panel, the reflector of the LCOS panel can be divided into electrically separate pixel electrodes which are used for controlling pixel sized areas of the liquid crystal layer through the application of electric fields from pixel drivers. A simplified illustration of various components of one conventional reflective type LCOS display panel having such a pixel electrode reflector can be seen in FIG. 1 in an exploded view. Conventional LCOS panel 10 includes a window 12, a transparent conductor 14, a liquid crystal (LC) layer 16, a pixel electrode reflector 18 and a pixel driver section 20. Above and below the LC layer are alignment layers 22 and 24 which orient the anisotropic liquid crystal layer. During operation of the panel, transparent conductor 14 can be maintained at a reference voltage while individual reflective pixel electrodes 26 (FIGS. 1 and 2) of the pixel electrode reflector can be driven with a drive voltage using the pixel drivers to create an electrical field between the pixel electrodes and the transparent conductor across the LC layer. The electric field causes pixel electrode sized portions of the LC to change a characteristic of light passing through the LC layer. Incident light 28 from a light source, (not shown), is directed to the panel and passes through window 12, transparent conductor 14 and LC layer 16 before reaching pixel electrode reflector 18 where the incident light is reflected. Reflected light 30 passes back through the LC layer and transparent conductor and exits the panel through the window.

As can be seen in FIG. 2, since these electrodes are electrically conductive and can be individually controlled separately from one another, the reflective pixel electrodes must be separated electrically from one another by gaps 34. Optical efficiency is reduced due to diffraction and absorption of light by the gaps. This problem grows worse as the pixel pitch (center-to-center spacing) is reduced in an effort to make displays and pico-projectors smaller and cheaper. One approach to solving this problem is to make the inter-pixel gaps smaller. This approach is limited by the “design rule” or minimum feature size achievable in the CMOS fabrication process of the display.

If reflective pixel electrodes 26 are square having a width w and a center-to-center spacing p (the pitch), then the fraction ff of the display area that is reflective is ff=(w/p)². This fraction of area covered by reflective pixel metal is known as the display's fill factor. If light falling in pixel gaps 34 is absorbed, the fraction of light reflected by the display will necessarily be less than the fill factor ff since the reflector's reflectivity is less than unity. However, an additional factor in optical efficiency is diffraction. Diffraction causes light to be deflected out of the main reflected beam into a series of many deflected angles that are determined by the ratio λ/p where λ is the light's wavelength. The fraction of diffracted light that is captured by an optical system and passed to the image seen by a viewer depends on the optical system's f/# as well as on the diffraction angles (which grow with shrinking pixel size). Slower optical systems, i.e. those with larger f/#'s, will capture less of the diffracted light, and hence have lower overall optical throughput, than faster optical systems with smaller f/#'s. The intensity of light that has been split into the various diffraction orders is proportional to the square of the fill factor, i.e. it is proportional to ff². The effect of diffraction and total reflective surface area combine to negatively impact optical efficiency.

In order to minimize the cost and size of a conventional display it can be desirable to use the smallest practical pixel pitch. The extent to which pixel pitch can be minimized can be limited by optics, VLSI circuit design, and VLSI fabrication process capabilities. In one instance in which a minimum pixel gap g is equal to width w of the pixel subtracted from pitch p, (g=p−w), the fill factor can be written in terms of the pitch and gap size as: ff=(1−g/p)². As the pixel pitch p is reduced, the fill factor, and thus the optical efficiency, drops. For example in a conventional display panel, if the pitch p=5.5 μm and g≈0.35 μm (w=5.15 μm), the corresponding fill factor is 0.88. In this example, at most, 88% of the incident light is reflected (assuming the gaps reflect no light) and the display must absorb 12% of the incident light without damage. The worst-case optical throughput, taking into account diffraction in this instance which would be relevant in an optical system with large f/#, would be ff²=(0.88)²=0.77 in which case at most 77% of the incident light is reflected and 23% is optical loss. It is desirable for the fill factor of a display to be as close to 1 as possible. The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic side view of certain layers of a conventional reflective type liquid crystal panel.

FIG. 2 is a diagrammatic top view of one of the layers of the conventional liquid crystal panel of FIG. 1.

FIG. 3 is a diagrammatic side view of an embodiment of a reflective type liquid crystal panel having an arrangement of layers according to the present disclosure.

FIG. 4 is a diagrammatic top view of a reflector layer of the liquid crystal panel shown in FIG. 3.

FIG. 5 is a diagrammatic top view of a transparent electrode array layer of the liquid crystal panel shown in FIG. 3.

FIG. 6 is a diagrammatic top view of another embodiment of a transparent electrode array of the liquid crystal panel shown in FIG. 3.

FIG. 7 is a graph showing calculated optical efficiency gains of the liquid crystal panel shown in FIG. 3 over the conventional liquid crystal panel shown in FIG. 1.

FIG. 8 is a graph showing the reflectivity of a combination of layers of the liquid crystal panel shown in FIG. 3 for certain thicknesses of one of the layers in a range of wavelengths of light.

FIG. 9 is an enlarged portion of the graph of FIG. 8.

FIG. 10 is a graph showing reflection and thickness of one of the layers of the liquid crystal panel as they relate to a refractive index of one of the layers.

FIG. 11 is a flow diagram illustrating an embodiment of a method for constructing a microdisplay panel.

FIG. 12 is another flow diagram illustrating another embodiment of a method for constructing a microdisplay panel.

### DETAILED DESCRIPTION

The following description is presented to enable one of ordinary skill in the art to make and use embodiments of the invention and is provided in the context of a patent application and its requirements. Various modifications to the described embodiments will be readily apparent to those skilled in the art and the generic principles taught herein may be applied to other embodiments. Thus, embodiments of the present invention are not intended to be limited to the embodiments shown, but are to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

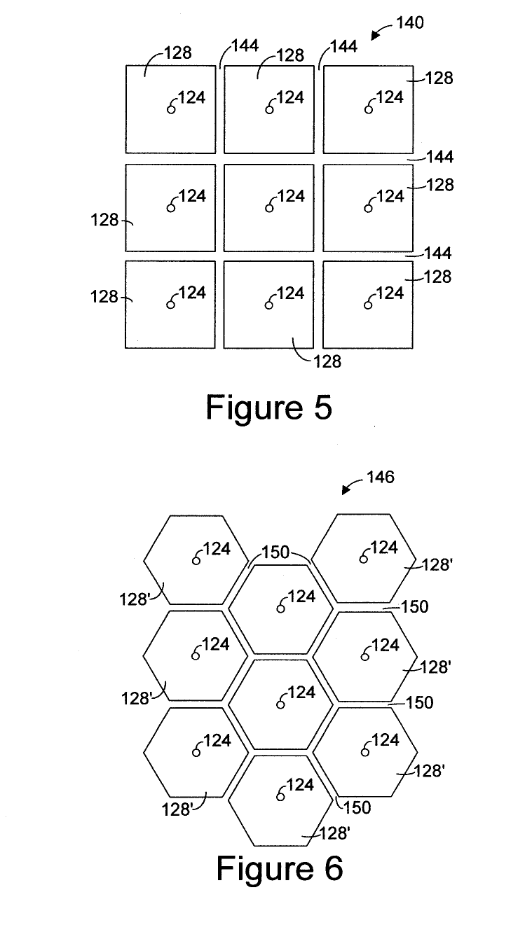

Attention is now directed to the remaining figures wherein like reference numbers may refer to like components throughout the various views. FIG. 3 is a diagrammatic representation of an embodiment of a liquid crystal on silicon (LCOS) panel in a side view, generally indicated by reference number 100. LCOS panel 100 includes a glass layer 102, a transparent conductive layer 104, a liquid crystal (LC) layer 106, a transparent electrode array 108, a transparent dielectric layer 110, a reflector 112 and drive circuitry 114. Incident light 116 enters the panel through the glass layer and reflected light 118 exits the panel after reflecting from reflector 112. LCOS panel 100 includes alignment layers 120 and 122 which are transparent and are used for aligning the liquid crystal material. Electrode conductors 124 electrically connect pixel drivers 126 of drive circuitry 114 to transparent pixel electrodes 128 of electrode array 108. Drive circuitry 114 can be an opaque substrate with the pixel drivers formed using VLSI CMOS semiconductor devices using conventional fabrication processes. The pixel drivers can be arranged in the substrate in an array to correspond to the electrode array. The LCOS panel can be formed on the substrate in a single monolithic structure.

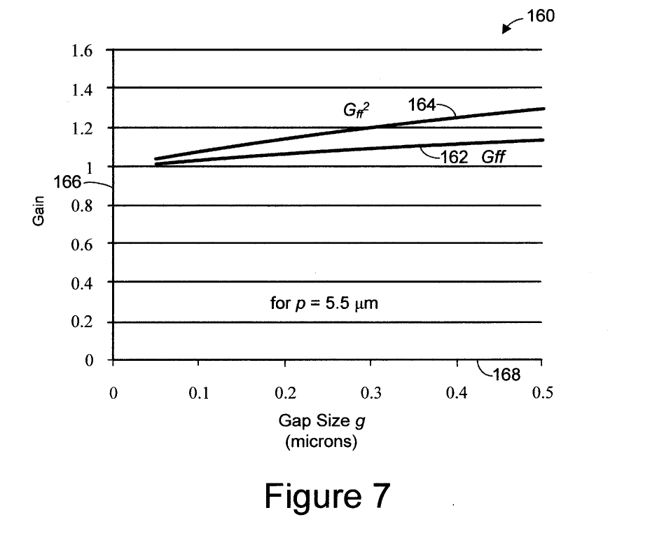

Referring now to FIG. 4 in conjunction with FIG. 3, reflector 112 is shown in a top view. Reflector 112 includes a reflective surface 130 that is only interrupted by through-holes 132 which electrode conductors 124 pass through to electrically connect the pixel drivers to the transparent electrodes. Reflective surface 130 can be metallic and can have a planar surface. A portion of electrode conductors 124 can also be formed by the same metallic material and can have a contact pad 134 that can be co-planar with the reflective surface. A remainder of electrode conductor 124 can be formed on contact pad 134 to extend between the contact pad and the transparent pixel electrodes.

Electrode conductors 124 are surrounded by gaps 138 where the conductors extend through the reflector. Gaps 138 electrically isolate the electrode conductors from reflector 112. The gaps can be filled with an insulating material or left empty. All or part of the electrical conductors can be the same material as the material used for the transparent pixel electrodes. In an embodiment in which the gaps are filled with the insulating material, the electrode conductors can be filled the transparent pixel electrode material in the same process used for forming the transparent pixel electrodes, although this may result in the pixel electrodes having a non-planar surface where the material enters the through-holes. A surface parallel to and intersecting with reflector 112 would also intersect electrode conductors 124. On this surface the electrically conducting area would be divided into two regions. The first region would be the contiguous region where the surface intersects reflector 112. The second region would be the union of non-contiguous areas where the surface intersects the various electrode conductors 124.

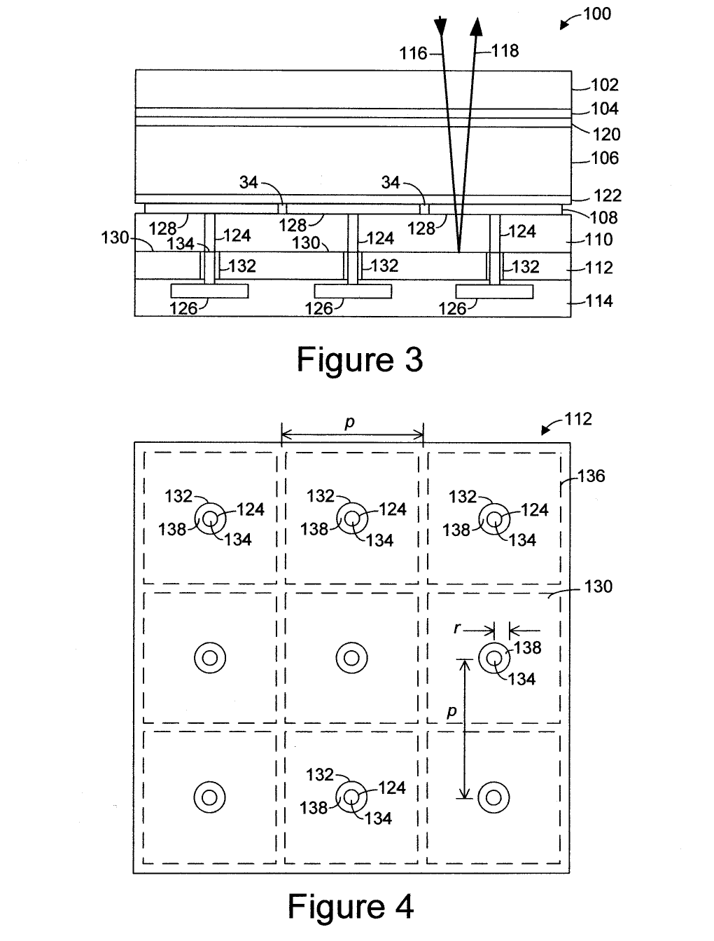

Even when they have the same linear dimension, through-holes 132 occupy less of the area of reflector 112 than do pixel gaps 34 in conventional reflector 18 (FIG. 2), so there is more reflective area on reflector 112 which can make reflector 112 more optically efficient than conventional reflector 18. The transparent pixel electrodes 128 have outside boundaries 136, shown in dashed line in FIG. 4. The region of liquid-crystal layer 106 associated with a particular pixel is generally the region corresponding with the particular pixel's electrode 128; however, the influence of the electrical state of a particular electrode 128 may extend laterally somewhat beyond the electrode's outside boundary so that even though there are gaps 34 between the pixel electrodes the optically responsive regions of adjacent pixels may touch. The through-holes can also occupy less area than pixel gaps between the outside boundaries of the pixel electrodes. Through-holes 132 can be arranged such that gap 138 and the entire through-hole 132 are confined within the electrode outer boundaries.

LCOS panel 100 which includes high fill factor reflector 112 can provide a higher optical efficiency than conventional LCOS panel 10 with reflector 18 that is divided up into reflective pixel electrodes. In LCOS panel 100, the reflector, which can be a metal such as aluminum, can be covered by transparent dielectric layer 110. Transparent dielectric layer 110 can be any suitable transparent dielectric, such as for example, silicon dioxide. The dielectric material may be selected to have an optical index of refraction that is larger or smaller than silicon dioxide for performance advantages, as is discussed in more detail below. Transparent electrode array 108 can be deposited over dielectric layer 110 which electrically isolates the transparent electrode array from the reflector and which electrically isolates individual transparent pixel electrodes 128 from one another since current does not flow through the dielectric layer between the pixel electrodes.

The transparent pixel electrodes of the transparent electrode array can define the areas of the liquid crystal that are controlled by each pixel driver. Transparent pixel electrodes 128 can be electrically connected to pixel drivers 126 using electrode conductors 124 that pass through the dielectric layer and the reflector. The electrode conductors can be formed, by way of non-limiting example, using indium-tin-oxide (ITO), tungsten, aluminum and/or other material that may be convenient to use in a fabrication process, such as a CMOS fabrication process. The electrode conductors can be made in the shape of cylindrical pillars or other suitable shape and can have a circular, elliptical, square or other cross-section or cross-sections.

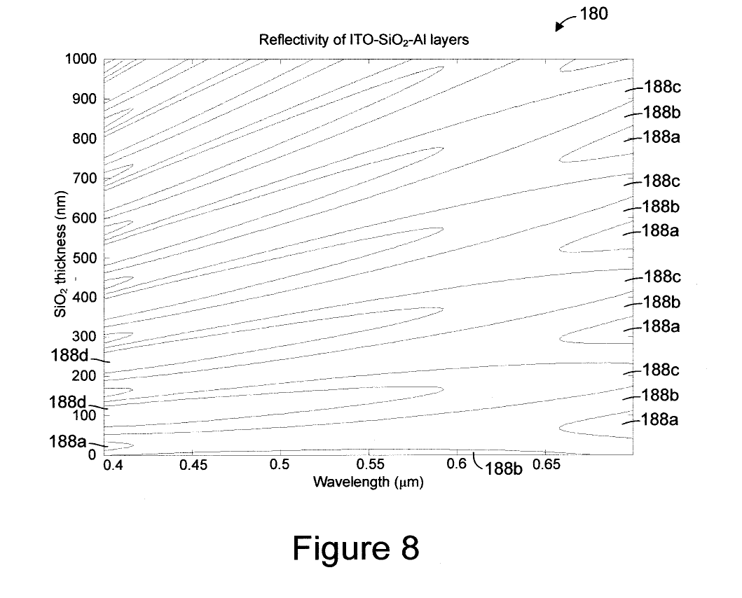

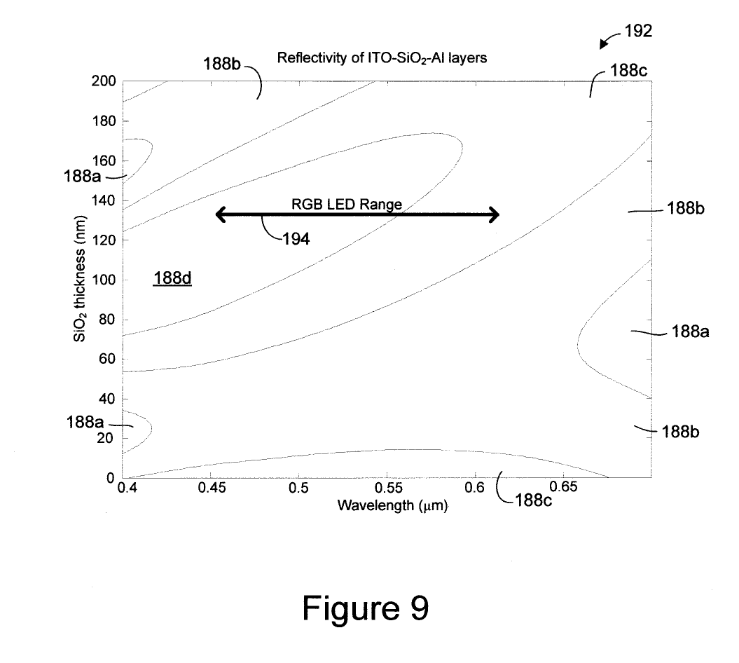

FIG. 5 is a top view of an embodiment of transparent electrode array 108. The transparent electrode array can be patterned in an array 140 of square shaped transparent electrodes 128 which are separated by gaps 144. In another embodiment, shown by FIG. 6, the transparent electrode array can be patterned in an array 146 of hexagonal shaped transparent electrodes 128′ which are separated by gaps 150. It should be appreciated that any suitable shape can be used for purposes of forming the transparent pixel electrodes. Gaps 144 and 150 between the transparent electrodes do not negatively impact the reflectivity of the display since the electrodes are transparent and serve to electrically isolate the transparent pixels from one another. The transparent electrode array can be patterned from a transparent conducting material. The transparent conducting material of transparent conductive layer 104 and transparent electrode array 108 can be indium-tin-oxide (ITO) or any transparent electrical conducting material either currently available or yet to be developed such as, for example, aluminum-doped zinc-oxide (AZO), indium-doped cadmium-oxide, or others. Organic alternatives such as PEDOT and PEDOT:PSS may also be suitable in addition to films made from carbon nanotubes or grapheme. The individual transparent electrodes can be formed from an overall continuous layer that is patterned, for example, by photolithography.

Referring again to FIG. 4, the fill factor of reflector 112 can be represented by equation (1.1):

ff=(p²−πr²)/p² (1.1)

Here, r is the radius of the through-hole that passes through the reflector and p is the pitch of the through-holes, which also corresponds to the pitch of the transparent pixels. The benefit (gain) of reflector 112 over a conventional patterned reflector can be determined by the ratio of fill factors represented by G_{ff} in equation (1.2):

$${G}_{ff} = \frac{{ff}_{new}}{{ff}_{old}} = \frac{1 - {π ( r / p )}^{2}}{{( 1 - g / p )}^{2}} \qquad ( 1.2 )$$

In an embodiment, electrode conductors 124 can have a diameter g and gap 138 can have a gap width g surrounding the electrode conductors where they pass through reflector 112 for electrical isolation from the reflector. In this case, through-hole 132 has a radius of r=1.5 g, such that the fill factor for this embodiment can be represented by equation (1.3):

ff=[1−π(3/2)²(g/p)²]. (1.3)

In this instance, the benefit (gain G_{ff}) of the LCOS panel utilizing reflector 112 over the conventional LCOS panel can be given by the ratio of fill factors in equation (1.4).

$${G}_{ff} = \frac{1 - {π ( 3 / 2 )}^{2} {( g / p )}^{2}}{{( 1 - g / p )}^{2}} \qquad ( 1.4 )$$

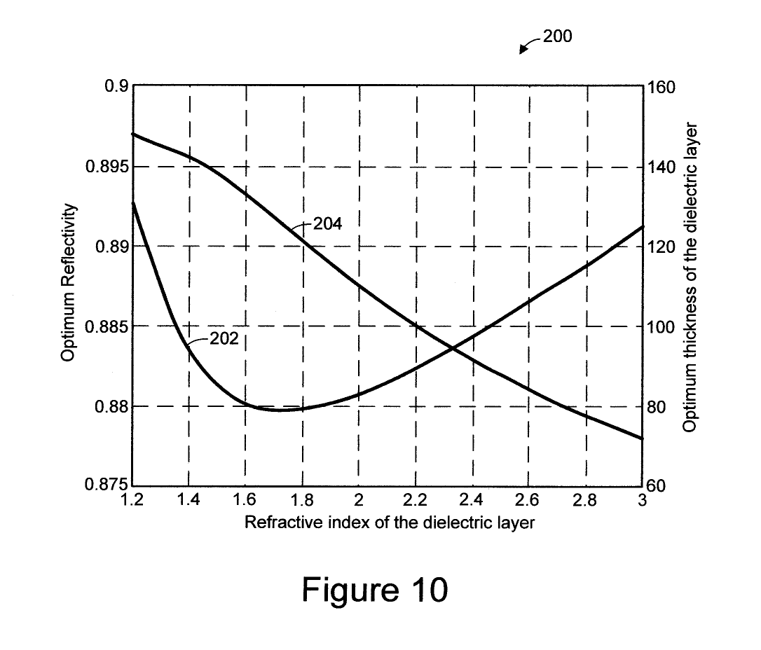

Turning now to FIG. 7, a graph 160 shows the optical efficiency gain G_{if} and gain squared (G_{ff})² for different gap sizes of the LCOS panel of the present embodiment and a LCOS panel having a conventional patterned reflector. Since the intensity of light that has been split into various diffraction orders can be proportional to the square of the fill factor, i.e. it is proportional to ff², the ratio of the fill factors squared (G_{ff})² can represent the gain taking into account the various diffraction orders, as would be particularly relevant to characterizing the performance of the LCOS panel in an optical system with large f/#. Graph 160 plots the gain G_{ff} 162 on one plot line and (G_{ff})² 164 on another plot line, using equation (1.4), on a y-axis 166 plotted against gap size g on an x-axis 168 for panels with a 5.5 μm pixel pitch. In an embodiment with g=0.35 μm and p=5.5 μm, an optical efficiency of G_{ff}=1.11 and (G_{ff})²=1.23 is gained over the conventional panel. Based on this result, the optical efficiency can increase 11% (without taking into account the diffraction) to 23% (taking into account the diffraction) for the microdisplay panel using the high fill factor reflector described. While the transparent electrode array and transparent dielectric layer are not perfectly transparent, these layers can introduce optical losses which may be in the range of 2-5%.

The total optical loss can be minimized based on the dielectric film thickness. In an embodiment, the reflector can be formed from a metal such as, for example, aluminum and transparent dielectric 110 can electrically insulate the transparent pixel electrodes from the electrically conductive metal reflector. If the metal reflector were a perfect reflector and the transparent dielectric and transparent pixel electrodes were perfectly transparent, the thickness of the dielectric could be selected to be a minimum required to electrically isolate the pixel electrodes from the reflector without any effect on optical efficiency. However, both the reflector and the transparent pixel electrodes do absorb a fraction of the incident light. The overall reflectivity of the metal reflector, the transparent pixel electrodes and the transparent dielectric can be adjusted based on selecting the thickness of the dielectric layer.

In a non-limiting example of an embodiment in which the thickness of the dielectric layer can affect the overall reflectivity, the reflector can be a perfect mirror and reflects 100% of incident light, the dielectric can be perfectly transparent and transmits 100% of incident light, and the transparent pixel electrodes can be imperfect and can absorb light. For a single wavelength of normally incident light the combination of incident and reflected light can form a standing wave with one node at the surface of the reflector and another node at a distance of one half wavelength from the reflector. If the thickness of the dielectric is chosen to be equal to λ/(2n), where n is the index of refraction of the dielectric and λ is the light's wavelength in vacuum, then the light's electric field at the position of the transparent conductor will be zero. In this case the light does not induce any electrical current within the transparent conductor and no light will be absorbed, despite the transparent conductor's imperfect optical properties.

Although in practice the dielectric can be treated as being substantially lossless, the minor in general is not lossless. The mirror's imperfection can introduce loss and can shift the phase of reflected light. Furthermore, typical optical systems must operate over the visible spectrum, i.e. not limited to a single wavelength, and must accommodate a range of incident angles dependent upon the optical system's f-number or numerical aperture, i.e. not limited to normal incidence. Therefore, an optimal thickness of the dielectric layer can be chosen to produce the best overall optical efficiency, averaged over a range of incident angles and over a range of optical wavelengths and including loss due to an imperfect minor.

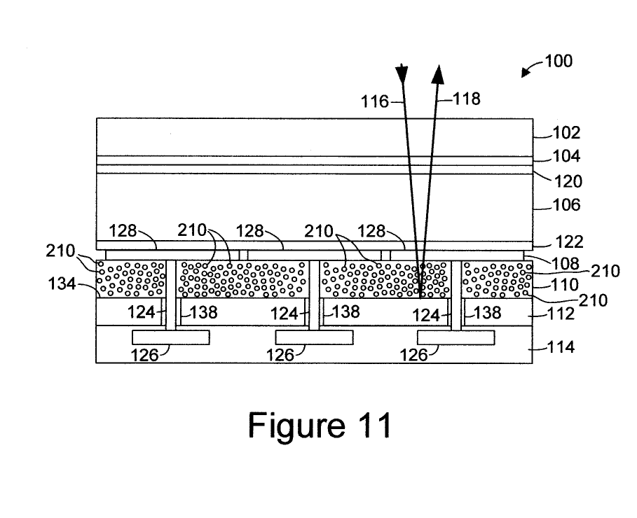

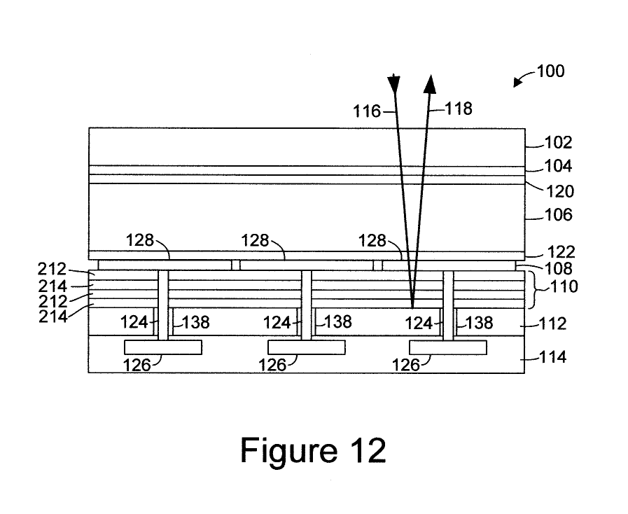

The reflectivity of combined Al—SiO₂-ITO layers can be computed vs. wavelength in an embodiment in which the reflector is aluminum, the transparent pixel electrodes are formed from ITO and the transparent dielectric is silicon dioxide (SiO₂) using the various refractive indices of the different wavelengths in the aluminum and ITO, as illustrated by FIGS. 8 and 9. In the embodiment illustrated in FIGS. 8 and 9, the ITO layer can be applied approximately 10.7 nm thick. FIGS. 8 and 9 are diagrammatic representations of original color plots that have been converted to topographical maps for purposes of conforming to the constraints imposed on patent drawings, but which nevertheless illustrate reflective regions of interest. The shown curves are contours of constant computed reflectivity. FIG. 8 is a topographic map 180 showing computed reflectivity of the combined Al—SiO₂-ITO layers for various SiO₂ thicknesses (nm), and various wavelength of incident light (μm), with various areas 188a-188d representing reflectivity. Area 188a represents overall reflectivity below approximately 0.81; area 188b represents overall reflectivity from approximately 0.81 to approximately 0.84; area 188c represents overall reflectivity from approximately 0.84 to approximately 0.87; and area 188d represents overall reflectivity over approximately 0.87. FIG. 9 is a graph 192 showing an area of graph 180 from FIG. 8 where Al—SiO₂ thickness is from 0-200 nm. As shown, high reflectivity can be obtained in areas 188c and 188d. For a given wavelength, e.g. 0.55 μm, it is apparent from FIG. 8 that reflectivity is a periodic function of SiO₂ thickness and that the choice of thickness for highest reflectivity is not unique. It is also apparent that reflectivity varies more rapidly with wavelength as the SiO₂ becomes thicker, so it is advantageous to choose the thinnest SiO₂ film having high reflectivity in order to maximize the range of wavelengths over which high reflectivity is obtained. In order to have a good reflectivity performance across the visible spectrum (e.g., RGB LED wavelengths of 617, 525 and 460 nm with a bandwidth of approximately 30-50 nm each) as represented by arrowed line 194, the plots of FIGS. 8 and 9 show that the SiO₂ layer can have a thickness of approximately 135 nm in this example.

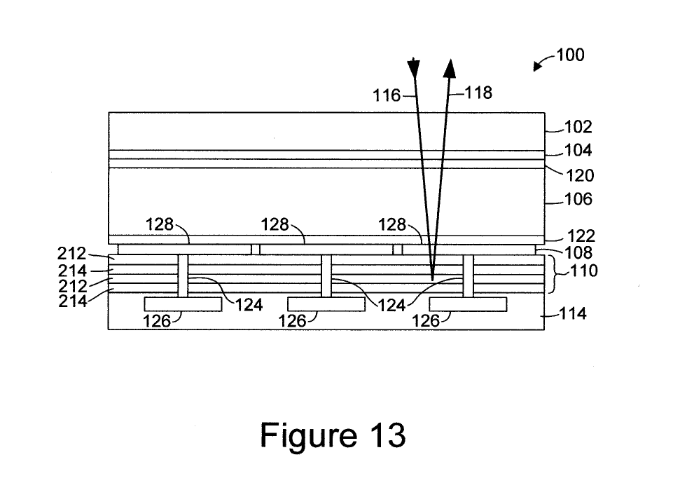

Referring now to FIG. 10, another parameter that can be selected to adjust reflectivity is the index of refraction of dielectric layer 110. A graph 200 shows a reflectivity 202 plotted against a refractive index of the dielectric layer, assuming an optimal choice of dielectric thickness for each value of refractive index. Optimal thickness 204 of the dielectric layer is plotted against the refractive index of the dielectric layer. Graph 200 uses an optical wavelength of 525 nm and an average refractive index of 1.6 for the liquid crystal. As can be seen based on reflectivity 202, the highest levels of reflectivity occur when the refractive index of the dielectric layer is at the maximum or minimum values shown. The lowest reflectivity occurs when the index of refraction of the dielectric layer is near the value of the index of refraction of the liquid crystal.

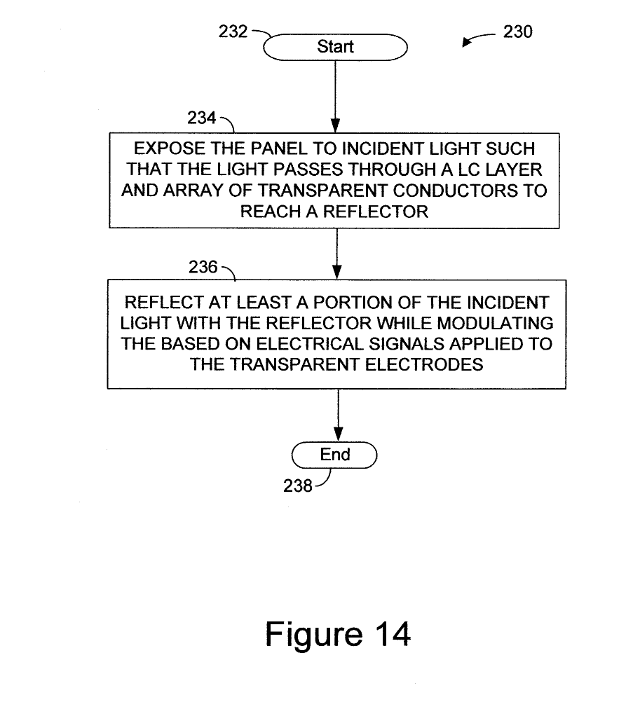

Other materials and arrangements of materials can also be used in addition to or in place of dielectric films made from materials such as SiO₂. Turning now to FIG. 11, structured materials may be used in order to achieve lower indices of refraction to provide high levels of reflectivity. For example, a SiO₂ film may be formed to contain sub-visible wavelength voids 210 having index of refraction n=1. The net index of refraction of the void-containing dielectric film can be intermediate to that of empty space and that of the dielectric material. In the instance where a SiO₂ film is obliquely deposited with voids, the net index of refraction of the material can be approximately n=1.08.

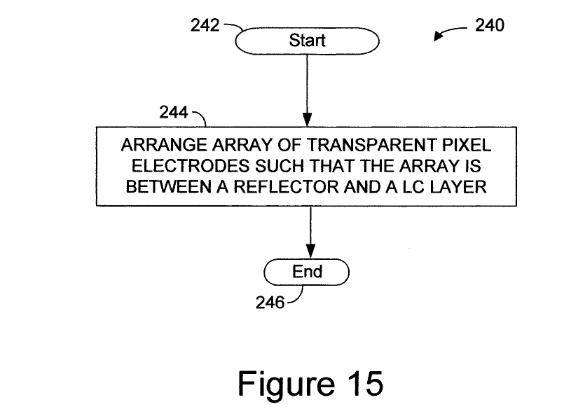

Turning now to FIG. 12, multiple dielectric films such as, for example, multiple films with alternating high index of refraction layers 212 and low index of refraction layers 214 can be arranged in a stack in place of a single dielectric film. The stack of films could be arranged to achieve a higher reflectivity than can be achieved by the single dielectric film. The multiple layer dielectric stack could mitigate optical loss due to absorption caused by an underlying, imperfect, metal reflector by reflecting some or all of the incident light prior to the light reaching the underlying reflector 112. In this case diffraction or absorption by the pixel gaps could be reduced or eliminated and the fill factor could approach close to 1. Using a multiple layer dielectric stack to reflect the entire incident light may introduce unwanted consequences in a conventional reflective type LCOS display panel in which the dielectric stack reflector is positioned between the pixel electrodes and the liquid crystal layer. The electric fields created with the reflective pixel electrodes in such a conventional display must extend across the dielectric layer as well as the liquid crystal layer and the dielectric can contribute to a voltage drop that can reduce the voltage available to switch the liquid crystal. The reduced switching voltage may result in slower or less complete switching of the liquid crystal and can require higher operating voltages to compensate for the reductions in switching voltage. These higher operating voltages may require circuitry with larger transistors and/or higher power consumption.

In FIG. 13 an even simpler structure is shown wherein no underlying metallic reflector, such as reflector 112 described with reference to FIGS. 3 and 12, is needed or utilized, with the multilayer stack of high and low-index dielectric films, 212 and 214, providing sufficient reflectivity on their own while also functioning to electrically isolate pixel electrodes 128 from underlying electronic circuitry 114. Since the reflector formed from films 212 and 214 is electrically insulating electrode conductors 124 now extend through the reflector without the need for the surrounding gaps 138 described previously with reference to FIG. 4. The pixel electrodes can be metallic. Since the underlying dielectric stack of films 212 and 214 is highly reflective, the pixel electrodes 128 could be patterned from a metal film that was so thin as to be at least partly transparent or could be fashioned from a metal film thick enough to be itself highly reflecting. Metal films utilized for pixel electrodes 128 are preferably made from a metals of high optical reflectivity such as aluminum or silver. Alternately, pixel electrodes 128 can be patterned from a transparent conducting film as previously described.

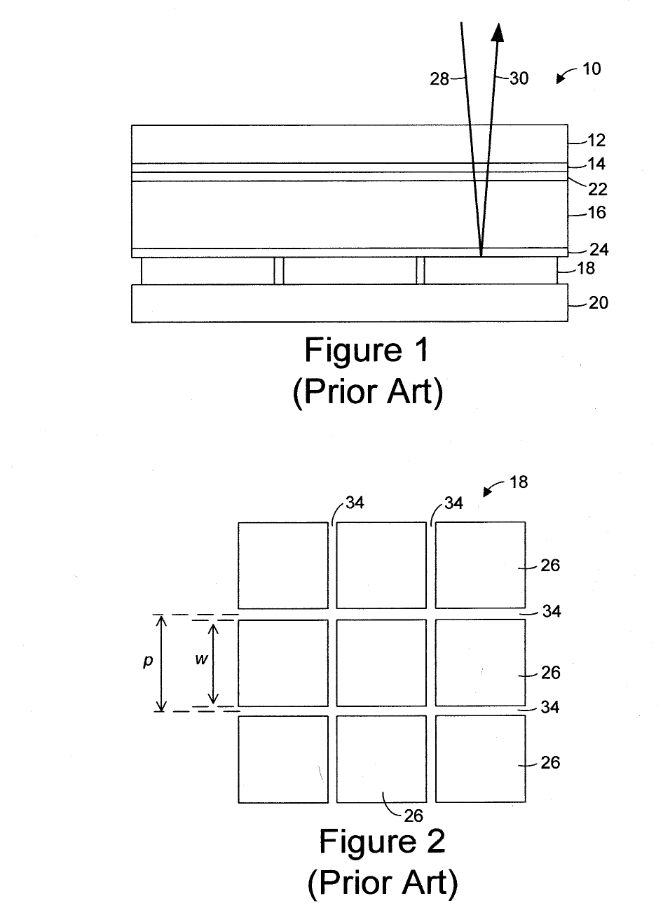

In general, it is desirable that the optical reflector in a reflective display or in an LCOS display have the highest possible fill factor. However, practicalities in the fabrication of such displays impose limits on the achievable fill factor. These limitations are often related to a “design rule” that characterizes the size of the smallest features that can practically be fabricated. In the case of the prior art display described with reference to FIGS. 1 and 2, reflector 18 must be separated into individual electrodes 26. This is accomplished by interrupting reflector 18 with gaps 34. Highest fill factor is obtained by minimizing the size of gaps 34, but the aforementioned fabrication limitations require that the gaps not be smaller than some minimum feature size or minimum gap width gₘᵢₙ. In the embodiments described with respect to FIGS. 3 through 15 it is also desirable to maximize the reflector fill factor. Again, the practicalities of the fabrication process may impose limitations on the highest achievable fill factor as a consequence of the minimum practical size for features that interrupt the reflector or reflecting layer. For example, in the embodiment described with reference to FIGS. 3 and 4, metallic reflector 112 is interrupted by electrode conductors 124 and their surrounding through-holes 132. Overall, the fill factor is maximized by minimizing the lateral size of conductors 124 and through-holes 132. If the minimum practical feature size is again denoted gₘᵢₙ, then conductor 124 cannot be smaller than a cylinder of diameter gₘᵢₙ and gap 132 also cannot be smaller than gₘᵢₙ, in which case the fill factor takes on the values expressed in equation (1.3) with g=gₘᵢₙ. Even in the case of the embodiment described with reference to FIG. 13, which may be practically fabricated without the need for gaps 132, the reflector is nevertheless interrupted by electrode conductors 124, which may be practically limited to cylinders of diameter no smaller than minimum feature size g=gₘᵢₙ, in which case the fill factor can have a maximum value of ff=1−(π/4)(g/p)².

Turning now to FIG. 14, a flow diagram illustrating an embodiment of a method of operating the microdisplay panel is generally designated by the reference number 230. Method 230 begins at a start 232 and proceeds to 234 where the microdisplay panel is exposed to incident light such that the incident light passes through a liquid crystal layer and an array of transparent electrodes to reach a reflector. Method 230 then proceeds to 236 where at least a portion of the incident light is reflected from the reflector while modulating the light based on electrical signals applied to the transparent electrodes. Method 230 then proceeds to 238 where the method ends.

Turning now to FIG. 15, a flow diagram illustrating an embodiment of a method in a liquid crystal display panel is generally indicated by the reference number 240. Method 240 begins at a start 242 and proceeds to 244 where layer of the microdisplay panel are arranged such than an array of transparent pixel electrodes is between a reflector and a layer of liquid crystal. Method 240 then proceeds to 246 where the method ends.

The foregoing descriptions of the invention have been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A microdisplay panel comprising:
a reflector for reflecting light through a layer of liquid crystal, the reflector having a reflective surface; and
an array of substantially transparent pixel electrodes defining a pixel array, the pixel array and the liquid crystal layer supported by the reflector and the pixel array positioned between the layer of liquid crystal and the reflector for selectively driving the pixels of the pixel array to modulate the reflected light with the liquid crystal layer.

2. The microdisplay panel of claim 1 further comprising:
an array of pixel drivers, each of which pixels drivers is electrically connected to one of the pixel electrodes by a pixel electrode conductor.

3. The microdisplay panel of claim 2 wherein the array of pixel drivers is on an opposite side of the reflector from the array of pixel electrodes and the pixel electrode conductors extend through the reflector to electrically connect the pixel drivers to the pixel electrodes.

4. The microdisplay panel of claim 3 wherein the pixel electrode conductors are electrically isolated from the reflector.

5. The microdisplay panel of claim 3 further comprising:
an opaque semiconductor substrate in which the array of pixel drivers are formed, the semiconductor substrate supporting the reflector.

6. The microdisplay panel of claim 1 further comprising:
a layer of transparent dielectric material between the pixel electrodes and the reflector.

7. The microdisplay panel of claim 6 wherein the dielectric material is silicon dioxide.

8. The microdisplay panel of claim 7 wherein the dielectric material is approximately 135 nm thick.

9. The microdisplay panel of claim 6 wherein the layer of dielectric material includes sub-visible wavelength voids.

10. The microdisplay panel of claim 1 wherein the reflector is formed with multiple layers of dielectric material that have at least two different indices of refraction.

11. The microdisplay panel of claim 10 wherein the layers of dielectric material alternate between relatively higher and relatively lower indices of refraction.

12. The microdisplay panel of claim 1 further comprising:
an alignment layer between the liquid crystal layer and the pixel array such that the alignment layer is adjacent to the liquid crystal layer on one surface and the alignment layer is adjacent to the pixel array on an opposite surface.

13. The microdisplay panel of claim 1 wherein the reflector is electrically conductive.

14. The microdisplay panel of claim 13 wherein the reflector is aluminum.

15. The microdisplay panel of claim 1 wherein the transparent pixel electrodes are patterned from indium-tin-oxide.

16. The microdisplay panel of claim 1 wherein the transparent pixel electrodes each have the same configuration.

17. The microdisplay panel of claim 1 wherein the transparent pixel electrodes are each rectangular shaped.

18. The microdisplay panel of claim 1 wherein the transparent pixel electrodes are each hexagonal shaped.

19. The microdisplay panel of claim 1 wherein the pixel electrodes define pixel boundaries and the reflector is continuous across the pixel boundaries.

20. A microdisplay panel comprising:
a liquid crystal layer;
a reflector arranged for reflecting incident light after passing through the liquid crystal layer; and
a transparent electrically conductive layer positioned between the liquid crystal layer and the reflective layer that is patterned to electrically define a pixel array, the reflector supporting the transparent electrically conductive layer and the liquid crystal layer.

21. A microdisplay panel comprising:
an array of transparent pixel electrodes that are each electrically connected for selective individual control to change a state of a pixel area of liquid crystal, the array positioned between the liquid crystal and a reflective surface such that at least a portion of light incident on the reflective surface is reflected by the reflective surface through the pixel electrodes and the liquid crystal, the pixel electrodes controllable using electrode conductors which extend through the reflective surface and which are electrically isolated from the reflective surface.

22. A microdisplay panel comprising:
a liquid crystal layer having a liquid crystal therein;
a transparent electrically conductive layer positioned on one side of the liquid crystal layer;
a transparent electrode array of transparent electrodes positioned on an opposite side of the liquid crystal layer from the transparent electrically conductive layer, wherein each electrode of the array is electrically isolated from other electrodes in the array and each electrode corresponds to a distinct pixel of the liquid crystal layer;
a pixel driver array of pixel drivers, each of which pixel drivers is electrically connected to one of the transparent electrodes by an electrode conductor and each of which pixel drivers is arranged for selectively producing an electric field between the transparent electrode and the transparent electrically conductive layer to electrically influence the liquid crystal in the distinct pixel area corresponding to each pixel of the pixel array; and
a reflective layer positioned such that the transparent electrode array is between the reflective layer and the liquid crystal layer, the reflective layer having a reflective surface for reflecting light incident on the reflective surface through the transparent electrode array, the liquid crystal layer and the transparent electrically conductive layer, the reflective layer defining conductor through-holes through which electrode conductors extend between the pixel drivers and the transparent electrodes.

23. A method in a liquid crystal microdisplay panel, comprising:
exposing the microdisplay panel to incident light such that the incident light passes through a liquid crystal layer and an array of transparent electrodes to reach a reflector; and
reflecting at least a portion of the incident light from the reflector while modulating the light based on electrical signals applied to the transparent electrodes.

24. The method of claim 23 further comprising:
applying the electrical signals to the transparent electrodes using pixel drivers positioned on an opposite side of the reflector from the array of transparent electrodes.

25. The method of claim 23 further comprising:
electrically insulating the array of transparent electrodes from the reflector with a transparent dielectric layer.

26. A liquid crystal display comprising:
a liquid crystal layer including an alignment layer and a liquid crystal material;
an array of pixels having a pitch p, the array of pixels comprising an array of pixel electrodes in contact with the alignment layer
electrode conductors connected to supply electrical signals to each of the pixel electrodes; and
a reflecting layer positioned on an opposite side of the array of pixels from the liquid crystal layer and supporting the array of pixels and liquid crystal layer, the reflecting layer interrupted in regions having a minimum feature size g and wherein the reflecting layer has a fill factor greater than (1−g/p)².

27. The liquid crystal display of claim 26, wherein the region of size g includes a contact pad that is electrically connected to one of the pixel electrodes in the array of pixels with one of the electrode conductors and the reflecting layer surrounds the contact pad in a plane.

28. The liquid crystal display of claim 26, wherein the electrode conductors extend through the reflecting layer and the interrupted regions of size g are where the electrode conductors extend through the reflecting layer.

29. A liquid crystal display comprising:
a liquid crystal layer including an alignment layer and a liquid crystal material;
an array of pixels spaced apart from one another, the array of pixels comprising an array of transparent pixel electrodes in contact with the alignment layer, the transparent pixel electrodes defining pixel boundaries; and
a metallic reflecting layer positioned on an opposite side of the array of pixels from the liquid crystal layer and supporting the array of pixels and liquid crystal layer, the reflecting layer having first and second metal regions separated by a gap, the gap having an area that is confined within the pixel boundary of one of the transparent electrodes of the array of pixels.

30. The liquid crystal display of claim 29, wherein the array of pixels are spaced apart from one another at a pixel pitch which defines an pixel gap around each pixel in the array, and wherein the area of the metal region gap is less than the area of the pixel gap.

31. The liquid crystal display of claim 29, wherein the metal region gap includes an outside boundary and the outside boundary of the gap is confined within the pixel boundary.

32. A liquid crystal display comprising:
a liquid crystal layer including an alignment layer and a liquid crystal material;
an array of pixels spaced apart from one another, the array of pixels comprising an array of transparent pixel electrodes in contact with the alignment layer, and
a metallic reflecting layer positioned on an opposite side of the array of pixels from the liquid crystal layer and supporting the array of pixels and the liquid crystal layer, and wherein a total reflective surface area of the metal layer is greater than a total area of the transparent pixel electrodes in the array of pixels.
